(19) United States
(12) Patent Application Publication
(10) Pub. No.: US 2013/0003022 A1
(43) Pub. Date: Jan. 3, 2013

(54) SCAN-TYPE IMAGE DISPLAY DEVICE AND SCAN-TYPE PROJECTION DEVICE

(76) Inventors: Teppei Tanaka, Yokohama (JP); Takeshi Nakao, Sagamihara (JP); Masato Sugiyama, Yokohama (JP); Michio Hatagi, Chigasaki (JP); Tomoto Kawamura, Yokohama (JP); Hiromi Kita, Hiratsuka (JP); Kunikazu Ohnishi, Yokosuka (JP)

(21) Appl. No.: 13/532,819

(22) Filed: Jun. 26, 2012

(30) Foreign Application Priority Data
Jul. 1, 2011 (JP) 2011-147275
Jul. 15, 2011 (JP) 2011-156260
Dec. 9, 2011 (JP) 2011-270403

(51) Int. Cl. G03B 21/14; G02B 26/10

(52) U.S. Cl. 353/20; 359/201.2; 359/485.06

(57) ABSTRACT

A polarizing prism is shaped in the form of a hexahedron. A polarizing beam splitter film (PBS film) is arranged approximately in a diagonal direction of the hexahedron. The polarizing prism holds a relationship of A<B when the dimension thereof in an outgoing direction (Y direction) of a light beam to a screen is A and the dimension thereof in an incident direction (X direction) of a light beam from a light source is B. For example, the polarizing prism is shaped in the form of a rectangular parallelepiped. At a plane on which the light beam is launched from a scanning mirror, one end of the PBS film is placed so as to intersect with the incident plane at an angle of approximately 45° at a position deviated inside by a difference between the dimensions A and B from the end of the incident plane.

### CLAIM OF PRIORITY

The present application claims priority from Japanese patent applications serial no. JP 2011-147275, filed on Jul. 1, 2011, no. JP 2011-156260, filed on Jul. 15, 2011, and no. JP 2011-270403, filed on Dec. 9, 2011, the contents of which are hereby incorporated by reference into this application.

### BACKGROUND OF THE INVENTION

(1) Field of the Invention

The present invention relates to a scan-type image display device and a scan-type projection device each of which two-dimensionally scans a light beam by a scanning mirror and displays an image on a screen.

(2) Description of the Related Art

A scan-type image display device and a scan-type projection device have recently been realized which respectively two-dimensionally scan a light beam emitted from a semiconductor laser light source on a screen by means of a scanning mirror (deflection mirror) and display an image thereon. There has been described in, for example, JP-A-2006-189573 and JP-T-2009-533715, as such a scan-type image display device, a device which is provided with a laser light source and a deflection scanning element (e.g., an MEMS (Micro Electro Mechanical Systems) mirror device) that reflects laser light emitted from the laser light source and scans the same on a projected plane and which rotates a mirror plane and thereby two-dimensionally scans a light beam emitted from its corresponding light source. At this time, the device assumes a configuration including a polarizing beam splitter (PBS) (or also called a polarizing beam-splitter cube or polarizing prism) and a ¼ wave plate. In this case, the polarizing beam splitter causes light reflected from a mirror to penetrate and throws (projects) the same onto a target for projection, and the ¼ wave plate is disposed between the polarizing beam splitter and the MEMS mirror device and polarizes and modulates transmitted light.

Referring to configurations shown in FIG. 6 of JP-A-2006-189573 and FIG. 20 of JP-T-2009-533715, the direction of incidence of a light beam on the scanning mirror is set to an approximately vertical direction (incident angle: approximately 0). These publications describe that the deflection angle of a beam to the rotating angle of a mirror plane is set at a large value. Since an optical path is shared between the light incident on the scanning mirror and the light reflected therefrom in this case, the light beam to be projected is taken as linearly polarized light, and the incident light and the reflected light are separated from each other using the polarizing beam splitter (PBS) and the ¼ wave plate provided in the optical path.

### SUMMARY OF THE INVENTION

It is known that in a scan-type image display device, distortion created in a displayed image lying on its screen depends on the angle of incidence of the light beam on the scanning mirror, and the image distortion becomes large in the case of beam incidence in the oblique direction. Therefore, the direction of incidence of the light beam on the scanning mirror is set to its vertical incidence to thereby make it possible to reduce the image distortion. In the case of vertical incidence, however, a polarizing beam splitter (PBS) is required to separate incident light and reflected light from each other. The PBS has a structure in which a multilayer film (hereinafter called a PBS film) is provided in a diagonal direction of a polarizing prism shaped in the form of an approximate cube and has properties that it principally causes P-polarized light to penetrate and reflects S-polarized light.

The size of an image projected by the scan-type image display device is determined by the deflection angle of the scanning mirror. In such an optical-system configuration as described in each of JP-A-2006-189573 and JP-T-2009-533715, all pieces of light reflected from the scanning mirror need to be passed through the polarizing beam splitter. Therefore, if the deflection angle becomes larger, the volume of the polarizing beam splitter also needs to be greater accordingly. A problem however arises in that increasing the volume of the polarizing beam splitter makes the entire casing larger in size and the parts cost also increases.

A problem arise in that the use of the polarizing beam splitter (PBS) degrades image quality since a bright spot occurs approximately in the central part of a projected image due to the interval reflection of the PBS.

An object of the present invention is to provide a scan-type image display device and a scan-type projection device which are capable of projecting a large image size in a simple configuration and are small in size and low in cost and which provide satisfactory image quality without causing unnecessary bright spots or the like.

The present invention provides a scan-type image display device which scans each light beam and displays an image on a screen. The scan-type image display device includes at least one light source which emits the light beam; a light source drive circuit which controls the intensity of the light beam emitted from the light source according to an image signal; a scanning mirror which causes the light beam to be incident on a mirror plane approximately vertically in such a manner that the light beam is approximately vertically reflected; a scanning mirror drive circuit which drives the scanning mirror such that its mirror plane two-dimensionally turns in a repetitive manner by a predetermined scan angle; and a polarizing prism which reflects the light beam incident from the light source in such a manner that the light beam is launched into the scanning mirror through a ¼ wave plate, the polarizing prism causing the light beam reflected by the scanning mirror and having passed through the ¼ wave plate to penetrate therethrough in such a manner that the light beam is projected on the screen. The polarizing prism is shaped in the form of a hexahedron and assumes a configuration in which a polarizing beam splitter film (PBS film) that reflects the light beam or allows the light beam to penetrate therethrough is disposed approximately in a diagonal direction of the hexahedron. When a dimension of the polarizing prism in an outgoing direction (taken as a Y direction below) of the light beam to the screen is A and a dimension thereof in a direction (taken as an X direction below) of incidence of the light beam from the light source is B, the polarizing prism holds a relationship of A<B.

The present invention provides a scan-type projection device which scans a light beam on a projected plane and projects a two-dimensional image thereon. The scan-type projection device includes at least one laser light source which emits the light beam as divergent light; a collimator lens which changes the light beam to approximately parallel light or weak convergent light; a deflection scanning element which scans the light beam on the projected plane; and a beam splitter which is disposed between the collimator lens and the deflection scanning element, the beam splitter causing the light beam after having passed through the collimator lens to reflect in a direction of the deflection scanning element, the beam splitter causing the light beam reflected by the deflection scanning element to penetrate in a direction of the projected plane. The beam splitter has a first plane on which the light beam after having passed through the collimator lens is incident, which is smaller in area than a second plane on which the light beam reflected from the deflection scanning element is incident.

According to the present invention, it is possible to achieve a scan-type image display device and a scan-type projection device which are capable of projecting an image having a large size in a simple configuration and which are small in size and low in cost.

### BRIEF DESCRIPTION OF DRAWINGS

These and other features, objects and advantages of the present invention will become more apparent from the following description when taken in conjunction with the accompanying drawings wherein:

FIG. 1 is an overall configuration diagram showing a first embodiment of a scan-type image display device according to the present invention;

FIG. 2 is a diagram illustrating the form of a polarizing prism in the first embodiment;

FIG. 3 is a diagram depicting the form of a second embodiment illustrative of a polarizing prism;

FIG. 4 is a diagram showing the form of a third embodiment illustrative of a polarizing prism;

FIG. 5 is a diagram depicting the form of a fourth embodiment illustrative of a polarizing prism;

FIG. 6 is a diagram illustrating the form of a related art polarizing prism for comparison;

FIG. 7 is a configuration diagram showing a fifth embodiment of a scan-type projection device according to the present invention;

FIG. 8 is a configuration diagram of a beam splitter in the fifth embodiment;

FIG. 9 is an explanatory diagram for determining the width of the beam splitter;

FIG. 10 is a diagram showing a configuration of a scan-type projection device using a related art beam splitter as a comparative example;

FIG. 11 is a configuration diagram of a scan-type projection device illustrating a modification of the fifth embodiment;

FIG. 12 is a perspective view showing a sixth embodiment illustrative of a beam splitter;

FIG. 13 is a perspective view illustrating a seventh embodiment illustrative of a beam splitter;

FIG. 14 is a plan view depicting an eighth embodiment illustrative of a beam splitter;

FIG. 15 is an overall configuration diagram showing a ninth embodiment of a scan-type image display device according to the present invention;

FIG. 16 is a diagram for describing the principle of generation of unnecessary stray light on a scan screen;

FIG. 17 is a diagram showing another configuration example of a transmission polarization selective element; and

FIG. 18 is a diagram illustrating a further configuration example of a transmission polarization selective element.

### DESCRIPTION OF THE PREFERRED EMBODIMENTS

The present invention will hereinafter be described in detail based on preferred embodiments illustrated in the accompanying drawings. The present invention is however not limited to or by the embodiments.

### First Embodiment

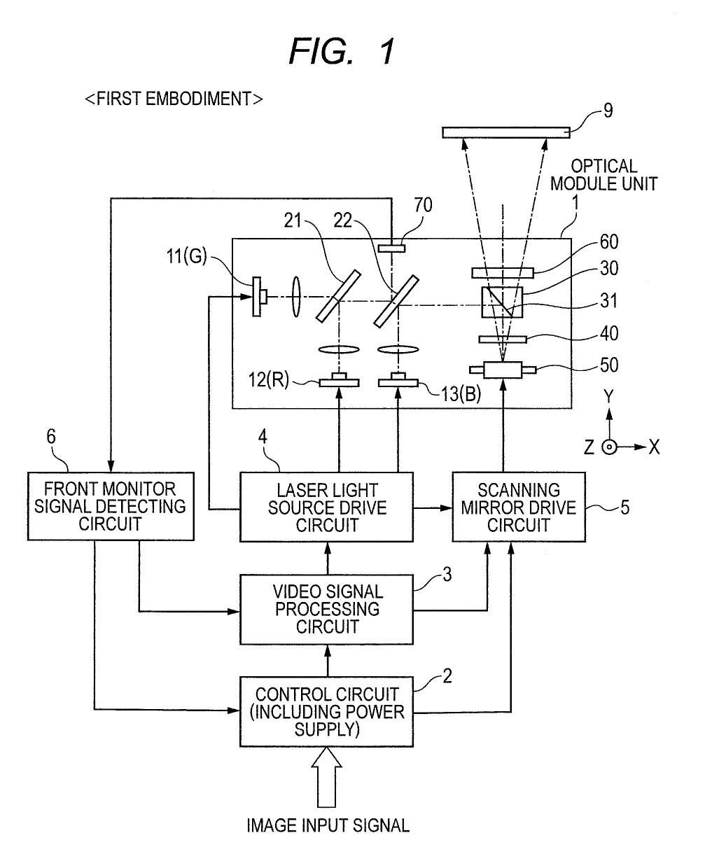

FIG. 1 is an overall configuration diagram showing a first embodiment of a scan-type image display device according to the present invention. A one-dot chain line in the drawing indicates an optical axis of each light beam. An optical module unit 1 has laser light sources 11, 12 and 13 of three colors of green (G)/red (R)/blue (B), an optical combination unit which combines light beams emitted from the laser light sources, a projection unit which projects the combined light beam onto a screen 9, and a scanning unit which two-dimensionally scans the projected light beam on the screen 9. The optical combination unit includes wavelength selective mirrors 21 and 22, etc. The projection unit includes a polarizing prism (polarizing beam splitter) 30 including a PBS (Polarizing Beam Splitter) film 31, a ¼ wave plate 40, a speckle reduction element 60, etc. The scanning unit includes a scanning mirror (deflecting mirror) 50, etc.

An image signal to be displayed is inputted to a video signal processing circuit 3 via a control circuit 2 including a power supply or the like. The video signal processing circuit 3 performs various processes on the image signal and separates the same into three color signals of R/G/B, followed by being sent to a laser light source drive circuit 4. The laser light source drive circuit 4 supplies light-emitting drive currents to their corresponding laser light sources 11, 12 and 13 in the optical module unit 1 according to brightness values of the signals of R/G/B. As a result, the laser light sources 11, 12 and 13 emit light beams having intensities corresponding to the brightness values of the R/G/B signals in matching with display timings.

The video signal processing circuit 3 extracts a synchronization signal from the image signal and sends it to a scanning mirror drive circuit 5. The scanning mirror drive circuit 5 supplies a drive signal for repeatedly rotating a mirror surface or plane on a two-dimensional basis to the scanning mirror 50 in the optical module unit 1 in accordance with a horizontal/vertical synchronizing signal. Thus, the scanning mirror 50 periodically repeatedly rotates the mirror plane by a predetermined angle to reflect the light beams. The scanning mirror 50 scans the light beams on the screen 9 in the horizontal and vertical directions to display an image.

A front monitor signal detecting circuit 6 inputs a signal from a front monitor 70 in the optical module unit 1 and detects output levels of R/G/B emitted from the laser light sources 11, 12 and 13. The detected output levels are inputted to the video signal processing circuit 3, where the outputs of the laser light sources 11, 12 and 13 are controlled in such a manner that they are brought to predetermined outputs.

An internal configuration of the optical module unit 1 will next be explained. The laser light source 11 generates a beam of G light (wavelength of 520 nm range), the laser light source 12 generates a beam of R light (wavelength of 640 nm range), and the laser light source 13 generates a beam of B light (wavelength of 440 nm range) respectively. The light beams of the respective colors are converted into approximately parallel light beams by collimator lenses. The wavelength selective mirror (dichroic mirror) 21 causes the G light to pass therethrough and reflects the R light. The wavelength selective mirror 22 causes the G and R light to pass therethrough and reflects the B light. The beams of the G, R and B light are adjusted in tilt and position relative to their optical axes so that the cross-sections of the beams are superimposed on one another, followed by proceeding as a combined single light beam. Incidentally, the layouts of the G, R and B light shown herein are determined in consideration of transmission efficiency of the light beams, but may be modified as appropriate without being limited to it.

The combined light beam enters the polarizing prism 30 and is reflected by the PBS film 31. The light beam passes through the ¼ wave plate 40 and enters approximately vertically into the scanning mirror (deflection scanning element) 50. The scanning mirror 50 is composed of, for example, an MEMS mirror or a galvanometer mirror or the like. Its mirror plane is repeatedly rotated at a predetermined scan angle on a two-dimensional basis to reflect the incident light beam approximately in the vertical direction in a scan angular range. The reflected light beam passes through the ¼ wave plate 40, penetrates through the PBS film 31 of the polarizing prism 30 and enters into the speckle reduction element 60. The speckle reduction element 60 is an element for reducing speckle noise produced due to interference with light returned from each optical part that the laser beam passes therethrough. The speckle reduction element 60 is composed of, for example, a liquid crystal element. The light beam that has passed through the speckle reduction element 60 is projected onto the screen 9, where an image is displayed. Incidentally, the speckle reduction element 60 may be omitted.

Next, the form and operation of the polarizing prism 30 which splits the light incident on the scanning mirror 50 and the light reflected from the scanning mirror 50 from each other will be explained. In order to make its description easy, the direction of incidence of the light beam inputted from the corresponding laser light source to the polarizing prism 30 is assumed to be an X direction, the direction of the center axis of the light beam reflected by the scanning mirror 50 and outputted to the screen 9 is assumed to be a Y direction, and the direction perpendicular to these and vertical to the sheet is assumed to be a Z direction. An image is displayed on the screen 9 two-dimensionally as viewed in the X and Z directions. The form of a related art polarizing prism will first be explained.

FIG. 6 shows the form of the related art polarizing prism 30 for comparison, in which FIG. 6(a) is a plan view thereof (as viewed from the Z direction), and FIG. 6(b) is a side view (as viewed from the X direction).

The polarizing prism 30 is approximately cubic in form. The lengths of the respective sides thereof, A (Y direction), B (X direction) and C (Z direction) are equal to each other. For example, the dimensions thereof need only A=B=C=8.4 mm to realize scan angles to be described below. The PBS film 31 is placed in a plane or surface that connects diagonal positions e and f of the polarizing prism 30 in the plan view (a). The angle which the surface of the PBS film 31 forms with the outer surface of the polarizing prism 30 becomes 45°. In the side view (b), the PBS film 31 is disposed over the entire surface of the polarizing prism 30 thereinside.

The light beam 81 emitted from the laser light sources 11, 12 and 13 and combined together is launched into the polarizing prism 30 in the X direction as S-polarized light. In order to bring the polarization of the incident light to S polarization, each laser light source or each collimator lens outgoing part may be provided with a polarizing plate, or each laser light source itself may be mounted with being rotated. The PBS film 31 of the polarizing prism 30 is disposed in a diagonal 45° direction and has a characteristic that it reflects S-polarized light and causes P-polarized light to penetrate therethrough. Thus, the light beam 81 of the S-polarized light is reflected by the PBS film 31 and proceeds in a −Y direction, and enters the ¼ wave plate 40. The light beam 81 of the S-polarized light is converted into a light beam of approximately circularly polarized light by the ¼ wave plate 40 and enters approximately vertically into the scanning mirror 50.

The scanning mirror 50 reflects the light beam in a +Y direction and its reflected beams 82 are swung at predetermined scan angles (θx in the X direction and θz in the Z direction). The magnitudes of the scan angles correspond to the size of the display screen. They are assumed to be θx (horizontal direction)=±15° and θz (vertical direction)=±12°, for example. The light beam 82 is converted from the light beam of the circularly polarized light to a light beam of P-polarized light by passing through the ¼ wave plate 40 again, followed by entering the polarizing prism 30. The light beam 82 of the P-polarized light penetrates through the PBS film 31 and is outputted from the polarizing prism 30 to the screen 9.

The polarizing prism 30 shown in FIG. 6 is susceptible to a further size reduction therein. In the plan view (a), the light beam 81 is reflected at one point corresponding to the center part of the PBS film 31 within the PSB film 31. The light beam 82 is penetrated therethrough at parts designated at symbols g through h. Outer parts e through g and h through f are not used. Likewise, in the side view (b), the light beams 81 and 82 are respectively reflected or penetrated in a region sandwiched between symbols 82, and parts each lying outside symbol 82 are not used. Therefore, the parts that the light beams do not pass are removed, thereby making it possible to reduce the size without any impairment in the function of the polarizing prism 30.

Some embodiments of size-reduced polarizing prisms will be explained below using drawings. Incidentally, in order to make a distinction between the six outer surfaces or planes of the polarizing prism 30, the plane on which each light beam 82 from the scanning mirror 50 falls is referred to as “an incident surface or plane 32”, the plane from which each light beam 82 is outputted to the screen 9 is referred to as “an outgoing surface or plane 33”, the plane on which the light beam 81 from the corresponding laser light source falls is referred to as “first side surface or plane 34”, the opposite plane facing the first side plane 34 is referred to as “a second side surface or plane 35”, the planes opposite to the Z direction are referred to as “an upper surface or plane 36” and “a lower surface or plane 37”. The positions of these planes are as shown in the drawings.

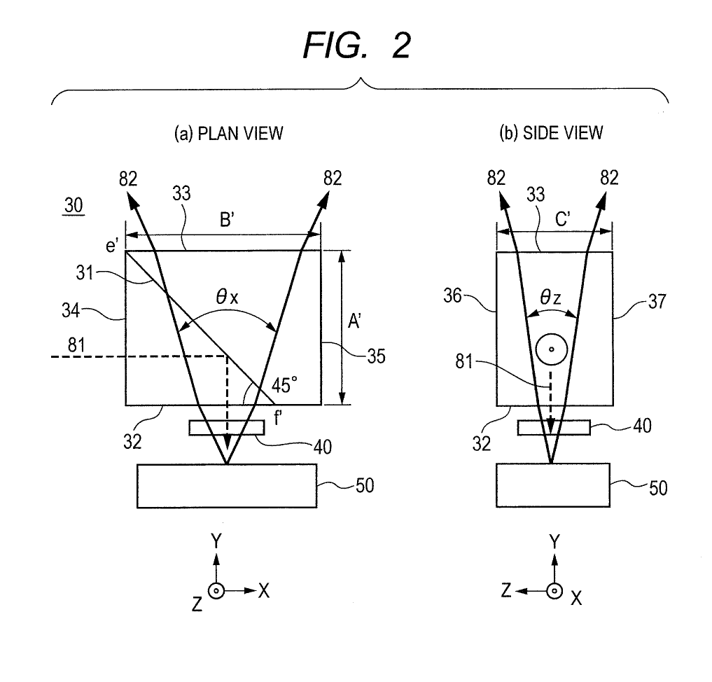

FIG. 2 shows the form of the polarizing prism 30 in the first embodiment, in which FIG. 2(a) is a plan view thereof, and FIG. 2(b) is a side view thereof. In the present embodiment, in the plan view (a), the incident or incoming plane 32 side of the polarizing prism 30 is eliminated and other three planes (outgoing plane 33 side, first side plane 34 side and second side plane 35 side) are eliminated with its removal. In the side view (b), the upper plane 36 side and the lower plane 37 side are eliminated. That is, when the dimensions of the respective sides are assumed to be A′ (Y direction), B′ (X direction) and C′ (Z direction), they are set as A′<A, B′<B and C′<C as compared with the pre-removal dimensions A, B and C (where A=B=C). Further, the post-removal polarizing prism 30 assumes a rectangular parallelepiped shape (whose XY section is rectangular in shape) and is placed in a relationship of A′<B′. Thus, the PBS film 31 is placed in the plane that connects a position f′ deviated inside from the corner (end) of the incident plane 32 and the corner (end) e′ of the outgoing plane 33. At the mention of an X-Y sectional shape, one end of the PBS film 31 and the other end thereof are laid out so as to intersect with the incident plane 32 at an angle of approximately 45° assuming that a vertex position e′ of a rectangular section is a starting point and a position f′ deviated inside from the vertex of the rectangular section as viewed on the incident plane 32 is an end point.

The removed parts of the polarizing prism 30 will be explained in contradistinction from FIG. 6 prior to the removal. In the plan view (a), the incident plane 32 side of the polarizing prism 30 is eliminated to a position indicated by a broke line j in FIG. 6. The removal position j is determined from the region of the PSB film 31 through which each light beam 82 does not pass, and is set to the proximity of the position h of intersection between the PBS film 31 and the light beam 82. With the elimination of the incident plane 32 side, the ¼ wave plate 40 and the scanning mirror 50 can be moved to the polarizing prism 30 side by its removal. As a result, each light beam 82 incident from the scanning mirror 50 becomes narrow in passage region (width in the X direction) of the PBS film 31 even though the scan angle θx is the same. Thus, the removal position j determined from the position of intersection with each light beam 82 further proceeds in the Y direction, and this operation is repeated to determine the final position.

Next, since the passage region for the light beams 82 becomes narrow, non-passage parts of the light beams 82 occur even on the first side plane 34 side and the second side plane 34 side. They are removed up to the positions indicated by broken lines m and n. In the outgoing plane 33 side, unnecessary parts are determined on the condition that all light beams 82 pass within the outgoing plane 33 and are outputted therefrom, and they are removed up to the position indicated by a broken line k. As a result, the dimension (depth) in the Y direction of the post-removal polarizing prism 30 is reduced to A′, and the dimension (width) thereof in the X direction is reduced to B′. If a concrete example is shown, the conventional dimensions A=B=8.4 mm are reduced to the post-removal dimension A′=6.6 mm and B′=7.8 mm where the scan angle θx=±15°. Since the relationship of A′<B′ is established in this case, the PBS film 31 has a feature in that it is disposed assuming, as a starting point, a position f′ deviated inside by the difference Δx=1.2 mm between the dimensions A′ and B′, which is other than the corner (end) position of the incident plane 32. Although the dimensions of A′ and B′ depend on the scan angle θx, the relationship of A′<B′ is always established. The more the scan angle θx increases, the larger the difference Δx between A′ and B′. Thus, when the scan angle θx is made large to enhance the resolution of a displayed image, a reduction effect can greatly be exhibited by increasing the difference Δx between A′ and B′.

In the side view (b), the upper plane 36 side of the polarizing prism 30 and the lower plane 37 side thereof are removed up to the positions indicated by broken lines p and q in FIG. 6. The removal positions p and q may be determined from the position where each light beam 82 intersects with the outgoing plane 33 in the post-removal polarizing prism 30 shown in the plan view of FIG. 2(a). As a result, the Z-direction dimension (height) of the post-removal polarizing prism 30 is reduced to C′. If a concrete example is shown, the conventional dimension C=8.4 mm is reduced to the post-removal dimension C′=6.8 mm where the scan angle θz=±12°. Incidentally, the dimension C′ depends on the scan angle θz, and a relationship of magnitude between the dimensions A′ and B′ is determined depending on the magnitude of θz.

### Second Embodiment

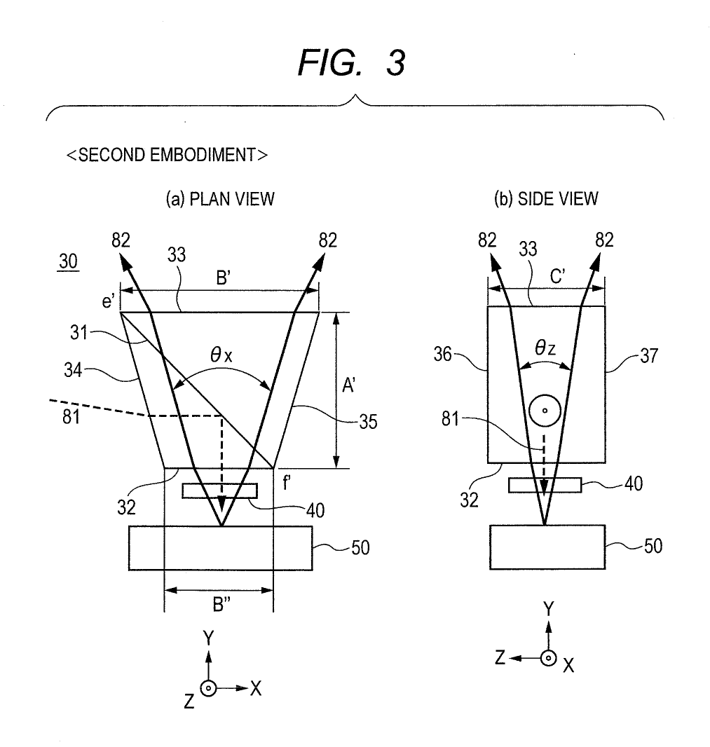

FIG. 3 shows the form of a second embodiment of a polarizing prism 30, in which FIG. 3(a) is a plan view thereof and FIG. 3(b) is a side view thereof. The present embodiment is a structure in which the polarizing prism of the first embodiment (FIG. 2) is further eliminated in plane. In the plan view (a), the first side plane 34 and the second side plane 35 of the polarizing prism 30 are obliquely cut in the traveling direction of each light beams 82. That is, the XY sectional shape becomes trapezoidal, and the dimension (width) B″ of the incident plane 32 is set smaller than the dimension (width) B′ of the outgoing plane and reduced to B″=5.5 mm. The PBS film 31 is placed in a plane that connects an angle f′ of the incident plane 32 and an angle e′ of the outgoing plane 33. At the mention of the XY sectional shape, one end of the PBS film 31 and the other end thereof are laid out so as to intersect with the short and long sides at an angle of approximately 45° assuming that a vertex position f′ of a the trapezoid on the short side (incident plane 32 side) is a starting point and a vertex position e′ of the trapezoid on its long side (outgoing plane 33 side) is an end point. The side view (b) is similar to the first embodiment (FIG. 2).

In the present embodiment, the size of the polarizing prism 30 can further be reduced by obliquely cutting the side surfaces or planes of the polarizing prism 30. Since the first side plane 34 on which the light beam 81 emitted from the corresponding laser light source falls is obliquely cut, the optical path of the light beam 81 after having been launched into the polarizing prism 30 changes. Therefore, the direction of the optical axis on the laser light source side is corrected to prevent the optical path in the polarizing prism 30 from changing.

### Third Embodiment

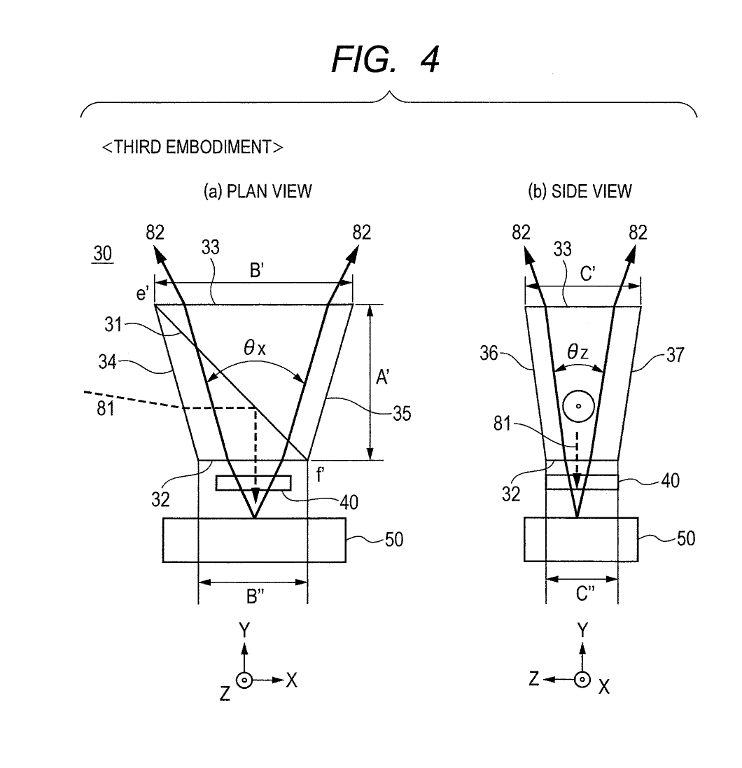

FIG. 4 shows the form of a third embodiment of a polarizing prism 30, in which FIG. 4(a) is a plan view thereof and FIG. 4(b) is a side view thereof. The present embodiment is a structure in which the polarizing prism of the second embodiment (FIG. 3) is further removed in plane. In the side view (b), the upper plane 36 and the lower plane 37 of the polarizing prism 30 are obliquely cut in the traveling direction of the light beams 82. Thus, the dimension (height) C″ of the incident plane 32 is set smaller than the dimension (height) C′ of the outgoing plane 33 and reduced to C″=5 mm. In the present embodiment, the upper and lower planes of the polarizing prism 30 are obliquely cut to make it possible to provide a size reduction in the polarizing prism on a three-dimensional basis. Even in the present embodiment, the direction of the optical axis on the laser light source side is corrected to prevent the optical path in the polarizing prism 30 from varying.

### Fourth Embodiment

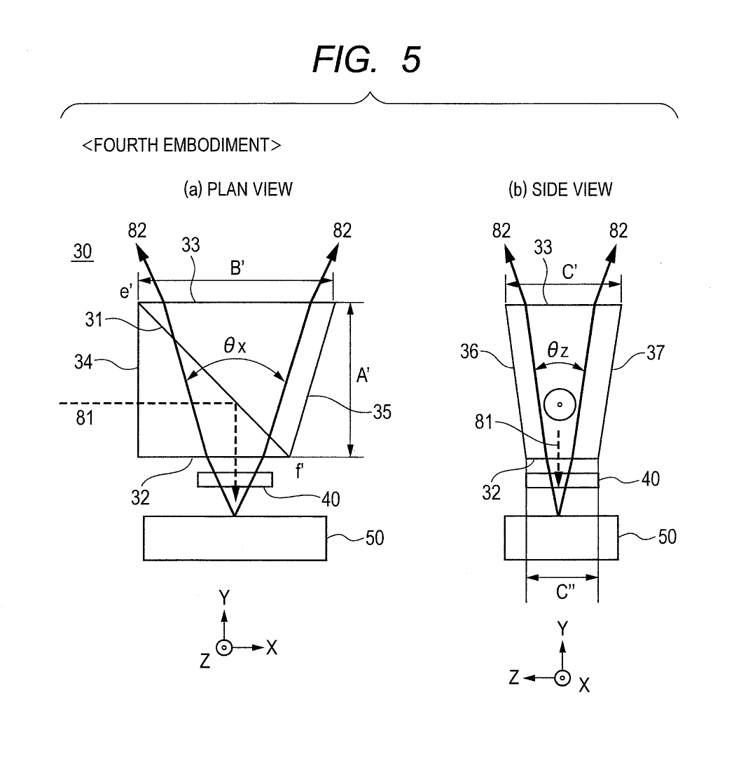

FIG. 5 shows the form of a fourth embodiment of a polarizing prism 30, in which FIG. 5(a) is a plan view thereof and FIG. 5(b) is a side view thereof. The present embodiment is a structure in which in the polarizing prism according to the third embodiment (FIG. 4), the first side plane 34 on which the light beam 81 emitted from the corresponding laser light source falls is returned to the plane similar to FIG. 2 without its oblique cutting. According to the structure, the optical path of the light beam 81 after having launched into the polarizing prism 30 remains unchanged. There is no need to correct the direction of the optical axis on the laser light source side.

According to the first through fourth embodiments described above, the parts that do not contribute to the generation of projection light in the polarizing prism are removed, thereby making it possible to reduce the size of the polarizing prism and achieve a size reduction in the scan-type image display device. The effect of its size reduction can greatly be exhibited by increasing the scan angle to perform a high-resolution image display. Incidentally, it is needless to say that the above embodiments are effective singly or even in combination, and the removal parts of the polarizing prism can be selected as appropriate.

### Fifth Embodiment

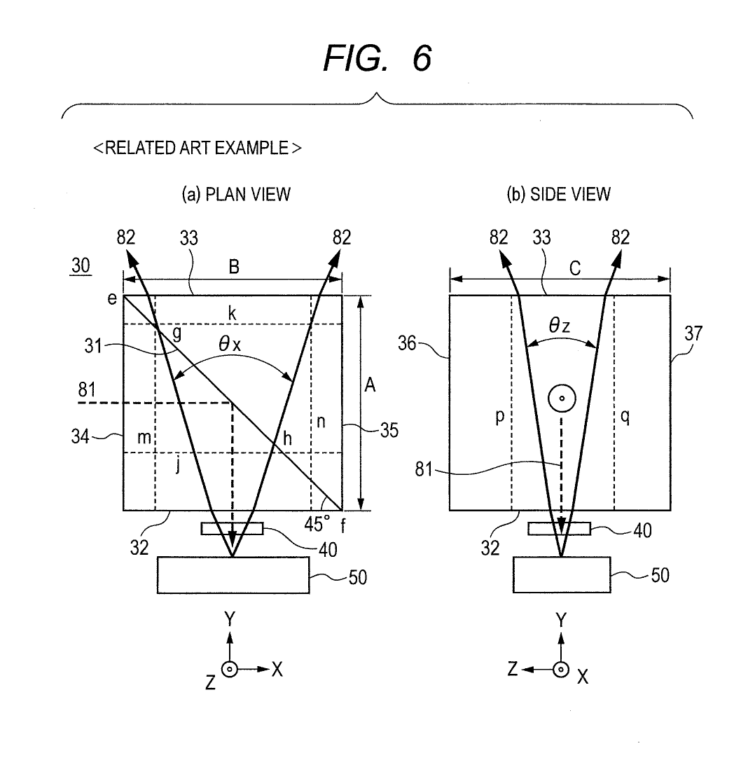

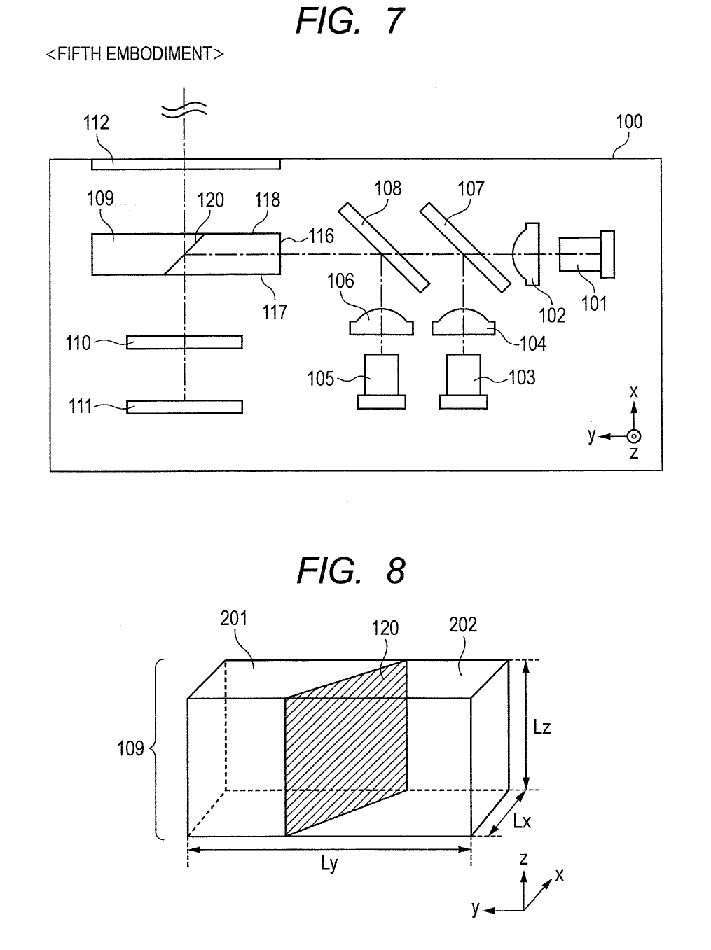

FIG. 7 is a configuration diagram showing a fifth embodiment of a scan-type projection device according to the present invention. The present embodiment is provided in which the size of a polarizing prism is further reduced as compared with each of the above embodiments. Here, there is shown a configuration of a scan-type projection device 100 (i.e., corresponding to the optical module unit 1 shown in FIG. 1) including a scaled-down beam splitter (polarizing prism) 109.

A laser light source 101, a laser light source 103 and a laser light source 105 are semiconductor lasers which emit a beam of G light (wavelength of 520 nm range), a beam of R light (wavelength of 640 nm range), and a beam of B light (wavelength of 440 nm range), respectively. The light beams emitted from the laser light sources 101, 103 and 105 are converted to parallel light beams or weak convergent light beams by collimator lenses 102, 104 and 106 respectively.

An optical combination element 107 is a wavelength selective mirror which causes the G light beam to pass therethrough and reflects the R light beam. The traveling direction of the R light beam is converted to a y direction in the drawing. Further, the optical combination element 107 or the laser light sources 101 and 103 and the collimator lenses 102 and 104 are adjusted in such a manner that the optical axes of the G and R light beams approximately coincide with each other. An optical combination element 108 is a wavelength selective mirror which causes the G light beam and the R light beam to pass therethrough and reflects the B light beam. The traveling direction of the B light beams is also converted to the y direction in the drawing. Further, the optical combination element 108 or the laser light source 105 and the collimator lens 106 are adjusted in such a manner that the optical axis of the B light beam and the optical axes of the G and R light beams approximately coincide with each other.

In general, a light beam emitted from a semiconductor laser is taken as linearly polarized light. Therefore, the light beams emitted from the laser light sources 101, 103 and 105 are also taken as linearly polarized light. In the present embodiment, the laser light sources 101, 103 and 105 are respectively rotatably adjusted in such a manner that the directions of polarization of the three light beams penetrated through the optical combination element 108 becomes approximately parallel to a z direction in the drawing.

The combined three-color light beam is launched into a beam splitter (polarizing prism) 109. Of the planes or surfaces that configure the beam splitter 109, attention is paid to the plane (first side plane) 116 on which each light beam falls, the plane (second side plane) 117 on which beam outgoing/incoming from and to a deflection scanning element 111 is performed, and the plane (third side plane) 118 on which beam outgoing (projection) to a projected plane is performed. Incidentally, the correspondences to the polarizing prisms 30 in the first through fourth embodiments (FIGS. 2 through 5) are as follows: The first side plane 116 corresponds to the first side plane 34, the second side plane 117 corresponds to the incident plane 32, and the third side plane 118 corresponds to the outgoing plane 33 respectively. In the present embodiment, the width (length in an x direction in the drawing) of the first side plane 116 is smaller than the width (length in the y direction in the drawing) of each of the second and third side planes 117 and 118, and their heights (lengths in the z direction in the drawing) are made equal to one another. That is, the beam splitter 109 is configured as a flat shape.

A polarization selective reflection film (PBS film) 120 is grown approximately in the center of the beam splitter 109. The polarization selective reflection film 120 has the property that it reflects a polarized component parallel to the z direction in the drawing and causes a polarized component parallel to the y direction in the drawing to pass therethrough. The polarization selective reflection film 120 is disposed at a predetermined angle in such a manner that the reflected light beams proceeds in a predetermined direction. In the embodiment of FIG. 7, for example, the polarization selective reflection film 120 is tilted by approximately 45° with respect to the planes 116 through 118 in such a manner that the reflected light beam is emitted approximately vertically from the plane 117. Since the three-color light beam incident on the plane 116 is adjusted to be the linearly polarized light approximately parallel to the z direction in the drawing as mentioned above, the polarization selective reflection film 120 reflects the three-color light beam in the direction of the plane 117.

The light beam emitted from the plane 117 of the beam splitter 109 enters into a ¼ wave plate 110. In the ¼ wave plate 110, the three-color light beam is converted to circularly polarized light. Next, the light beam is launched into the deflection scanning element (scanning mirror) 111. The deflection scanning element 111 has the function of two-dimensionally scanning the light beam on the projected plane by being deflectively driven about scan axes as the z and y directions in the drawing being taken as the scan axes. The deflection scanning element 111 can be achieved by using, for example, an MEMS mirror or a galvanometer mirror or the like.

The light beam reflected by the deflection scanning element 111 enters into the ¼ wave plate 110 again. In the ¼ wave plate 110, the light beam is converted to the linearly polarized light in the y direction in the drawing. Next, the light beam passes through the plane 117 of the beam splitter 109 again and enters the polarization selective reflection film 120. Here, the polarization selective reflection film 120 causes the light beam to penetrate therethrough because the polarization direction of the light beam has been converted parallel to the y direction in the drawing by the ¼ wave plate 110. Even when the deflection scanning element 111 takes a predetermined maximum deflection angle, although not shown in the drawing, the second side plane 117 and the third side plane 118 respectively assume a predetermined area in such a manner that the deflected light beam passes within the beam splitter 109. Incidentally, when the deflection-scanned light beam passes through the outside of the polarization selective reflection film 120 of the beam splitter 109 without being launched into the polarization selective reflection film 120, it results in the equality that the light beam penetrates through a mere transparent flat plate. This is assumed to be allowed.

Subsequently, the light beam enters a transparent cover 112 provided at the upper surface of the scan-type projection device 100. The transparent cover 112 is assumed to be a cover of transparent glass or plastic sufficiently high in transmittance of the three-color light beam and is capable of preventing degradation in the transmittance of each optical part and a failure in the deflection scanning element 111 and the like due to dust or the like that intruded in the device 100. Even when the deflection scanning element 111 takes a predetermined maximum deflection angle, the transparent cover 112 also assumes a predetermined area in such a manner that the deflected light beam passes through the transparent cover 112 without any loss. The three-color light beam having passed through the transparent cover 112 forms three light spots so as to overlap at the same position on the plane of projection placed outside. That is, the three-color light beam can be visually identified on the projection plane as a single light spot.

As described above, the scan-type projection device 100 according to the present embodiment may be made up of at least the laser light sources 101, 103 and 105, the collimator lenses 102, 104 and 106, the optical combination elements 107 and 108, the beam splitter 109, the ¼ wave plate 110, the deflection scanning element 111 and the transparent cover 112. There is no problem even in the case of addition of optical elements such as a diffraction grating, a wave plate, etc. in midcourse thereof or a configuration in which an optical path is folded back by a mirror. There is also no problem even when an optical element or the like having the function of converting the scan angle of the deflection scanning element 111 is added to the optical path formed between the transparent cover 112 and the deflection scanning element 111.

FIG. 8 is a perspective view showing a concrete configuration of the beam splitter 109 in the fifth embodiment. The drawing shows as one example where the beam splitter 109 takes the form of a rectangular parallelepiped. The beam splitter 109 can be fabricated by forming a polarization selective reflection film 120 on the mating face between glass 201 and glass 202 and cutting out it to form a rectangular parallelepiped. Since this is similar to the fabrication process of the polarizing beam-splitter cube of JP-A-2006-189573, it is easy to fabricate the beam splitter.

Assume that the length of the beam splitter 109, which extends along an x direction in the drawing, is a width Lx, the length thereof extending along a y direction in the drawing is a width Ly, and the length thereof extending along a z direction in the drawing is a width Lz. A description will now be made of a concrete relational expression between the widths Lx, Ly and Lz of the beam splitter 109.

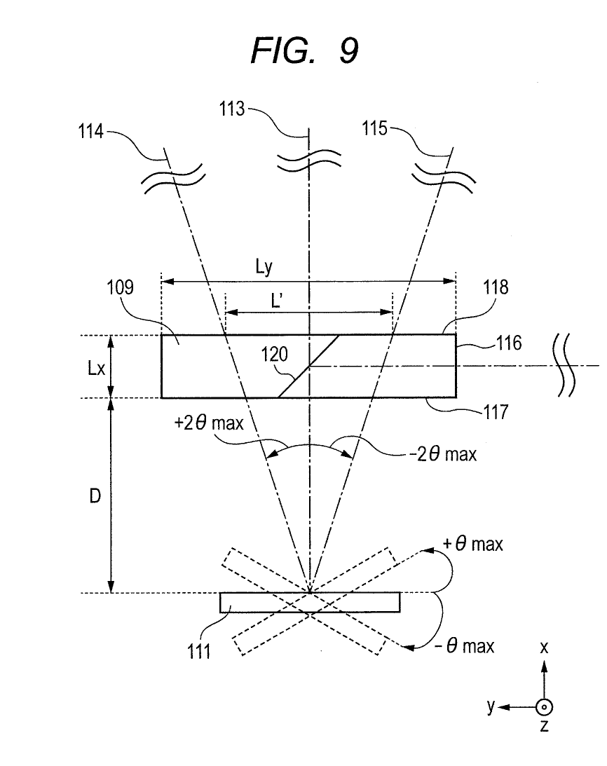

FIG. 9 is an explanatory diagram for determining the width Ly of the beam splitter 109. Incidentally, in order to simplify the drawing, only the beam splitter 109 and the deflection scanning element 111 are described. The second side plane 117 and the third side plane 118 of the beam splitter 109 respectively have a predetermined area in such a manner that all the incident light beams pass through within the beam splitter 109 even though the incident angle of the deflection-scanned light beam is changed by the deflection scanning element 111.

The maximum deflection angle taken where the deflection scanning element 111 is rotated with a straight line passing through its center and parallel to the z direction in the drawing being taken as an axis, is assumed to be ±θmax. Here, the clockwise rotation on the sheet is assumed to be negative, and the anticlockwise rotation on the sheet is assumed to be positive. The optical axis of a reflected light beam where the deflection angle of the deflection scanning element 111 is zero, is assumed to be an optical axis 113, the optical axis of a reflected light beam where the deflection angle is +θmax, is assumed to be an optical axis 114, and the optical axis of a reflected light beam where the deflection angle is −θmax, is assumed to be an optical axis 115. The angle formed between the optical axis 113 and the optical axis 114 becomes +2·θmax, the angle formed between the optical axis 113 and the optical axis 115 becomes −2·θmax, and the maximum deflection scan angle for the light beam becomes ±2·θmax.

Assuming that the distance between the plane 117 of the beam splitter 109 and the deflection scanning element 111 is D and the refractive index of the beam splitter 109 is n, the maximum width L′ extending along the y axis in the drawing at which the light beam up to the maximum deflection scan angle is incident on the third side plane 118, is given from the following equation (1):

L′=2×(D+Lx/n)·tan(2·θmax). (1)

Assuming that the diameter of the light beam is S, the width Ly needs to meet the following equation (2) in order to cause all light beams incident at the deflection angle between the optical axis 114 and the optical axis 115 to pass through the third side plane 118:

Ly>S+L′=S+2×(D+Lx/n)·tan(2·θmax) (2)

Although not shown in the drawing, the width Lz of the third side plane 118 extending along the z direction in the drawing can be determined in like manner. The maximum deflection angle is assumed to be ±φmax where the deflection scanning element 111 is rotated with a straight line passing through its center and parallel to the y direction in the drawing being taken as an axis. In order to cause all light beams to pass through the third side plane 118, the width Lz needs to satisfy the following equation (3):

Lz>S+2×(D+Lx/n)·tan(2·φmax) (3)

On the other hand, the light beam incident on the first side plane 116 is an outward light beam which travels toward the deflection scanning element 111, and its deflection angle remains unchanged. Accordingly, the width Lx of the first side plane 116 may be expressed in the form of the following equation (4) using the beam diameter S:

Lx>S (4)

As described above, the widths Ly, Lz and Lx of the beam splitter 109 in the present embodiment may be determined so as to satisfy the equations (2), (3) and (4).

Subsequently, the advantageous effects of the beam splitter 109 in the present embodiment will be explained.

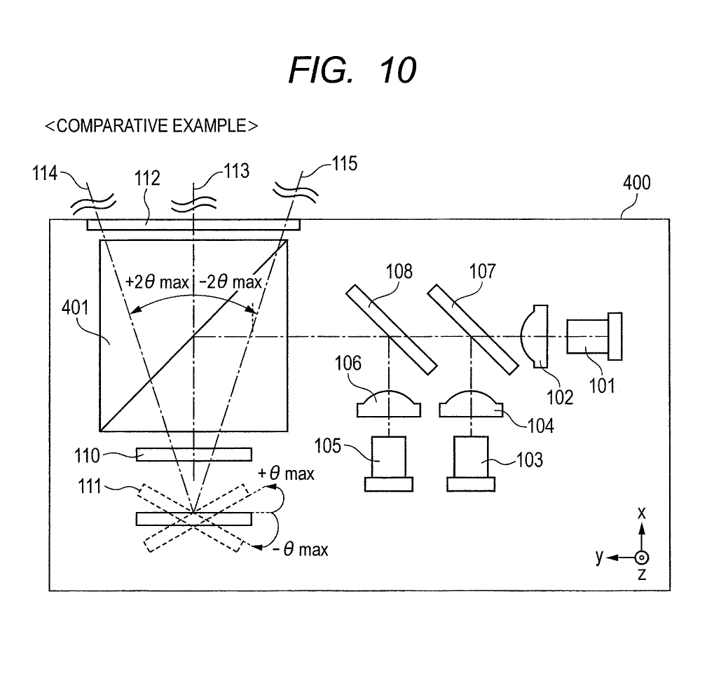

FIG. 10 shows a configuration diagram of a scan-type projection device 400 where a related art beam splitter is used as a comparative example. There is shown, for example, the case where the polarizing beam-splitter cube 401 is adopted in which the xy section described in the JPA-2006-189573 is square.

In order to cause the light beams having the maximum deflection angle ±2·θmax to penetrate through the polarizing beam-splitter cube 401 as shown in the drawing, there is a need to increase the volume of the polarizing beam-splitter cube 401. It is further essential that the maximum deflection angle is further enlarged to project an image having a large size by the scan-type projection device. Correspondingly, the volume of the polarizing beam-splitter cube 401 further increases. An increase in the volume of the polarizing beam-splitter cube 401 turns into not only a problem that the entire scan-type projection device 400 is made large in size, but also a problem that the price of each part increases. Each optical part having polarization dependence is normally made of glass. Assuming that the polarizing beam-splitter cube 401 is also made of glass, the larger the size of each part, the less the acquired number of parts obtained from a sheet of glass substrate. This will increase the price of each part. Thus, of the entire cost of the scan-type projection device 400, an impact occupied by the polarizing beam-splitter cube 400 becomes extremely large.

The beam splitter 109 of the scan-type projection device 100 according to the present embodiment assumes a configuration in which the area of the first side plane 116 is made smaller than the areas of the second and third side planes 117 and 118. In this case, the outward light beam proceeding to the deflection scanning element 111 and remaining almost unchanged in incident angle is incident on the area of the first side plane 116. In addition, the outward light beam that is scanned by the deflecting scanning element 111 and greatly changes in incident angle is incident on the areas of the second and third side planes 117 and 118. With this configuration, the thickness of the beam splitter 109 can be made sufficiently thin, and the volume thereof can also be reduced drastically. Thus, the miniaturization of the entire scan-type projection device 100 is enabled. In addition to it, the effect of greatly reducing the price of each part by increasing the acquired number of parts obtained from the single glass substrate is also brought about.

Even where the maximum deflection angle for the light beams is made large to increase the size of a projection image, the widths Ly and Lz may be made long and the width Lx may be used as it is. That is, even though the maximum deflection angle is made large, the thickness of the beam splitter 109 remains unchanged. It is thus possible to prevent a large increase in the volume of each part for the beam splitter 109. Consequently, the miniaturization of the scan-type projection device 100 and the effect of reducing its cost can be obtained. Further, since the miniaturization and the cost reduction can be achieved simply by using the beam splitter 109, an increase in the number of the optical parts and complication of an optical system do not take place.

As described above, the scan-type projection device 100 according to the present embodiment is capable of projecting a large image size while using the beam splitter small in size and achieving its size reduction and low cost.

Incidentally, the scan-type projection device of the present embodiment can be modified as follows:

The optical combination elements 107 and 108 which combine the three-color light beams of G, R and B together, have been assumed to be the wavelength selective mirrors. The scan-type projection device according to the present embodiment, however, may take a configuration which combines the light beams of the three colors or may take a configuration using two wavelength selective prisms instead of the two wavelength selective mirrors.

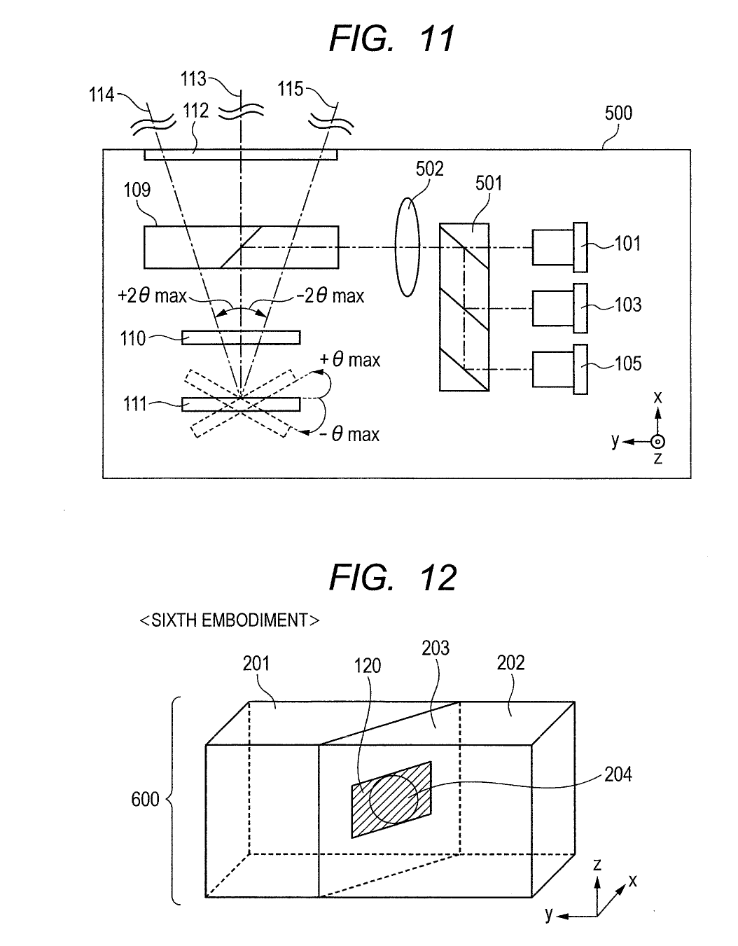

There is no problem even though as in a scan-type projection device 500 shown in FIG. 11, light beams of three colors are combined together by an optical combination element 501 combined with the functions of optical combination elements 107 and 108 and thereafter the light beams of three colors are combined to make conversion into parallel light by one collimator lens 502. Further, although not shown in the drawing, one wavelength selective cross prism generally used in a liquid crystal projector or the like may be used instead of the optical combination element 501.

The layout of the laser light sources for green, red and blue are not limited to the present embodiment but may be different therefrom.

The deflection scanning element 111 may be composed of two deflecting mirrors singly provided with rotational axes approximately vertical to each other.

The beam splitter 109 of the present embodiment is not necessarily required to be composed of glass and may be made up of transparent plastic.

### Sixth Embodiment

FIG. 12 is a perspective view showing a sixth embodiment of a beam splitter. The above beam splitter 109 may be configured so as to reflect the light beam having passed through the optical combination element 108 toward the deflection scanning element 111. Thus, like a beam splitter 600 shown in FIG. 12, a polarization selective reflection film 120 formed on a mating face 203 between glass 201 and glass 202 may be provided in a limited area including the position of incidence of an outward light beam 204 incident on the mating face 203 from a laser light source, and its proximity. Although the shape of the polarization selective reflection film 120 is set as quadrangular in the drawing, its shape is not limited to it, but may be approximately circular or a polygon or the like.

Each of the beam splitters 109 and 600 may take such a configuration as to reflect the outward light beam having passed through the optical combination element 108 toward the deflection scanning element 111 and cause the outward light beam reflected by the deflection scanning element 111 to penetrate toward the projected plane. The beam splitter may take, for example, a configuration which has the function opposite to the polarization selective reflection film 120 and rotatably adjusts the laser light sources 101, 103 and 105 in such a manner that the light beam having passed through the optical combination element 108 assumes a polarization direction parallel to a y direction in the drawing, using a polarization selective reflection film that reflects a polarized light beam approximately parallel to the y-axis direction in the drawing and causes a polarized light beam approximately parallel to a z direction in the drawing to pass therethrough.

### Seventh Embodiment

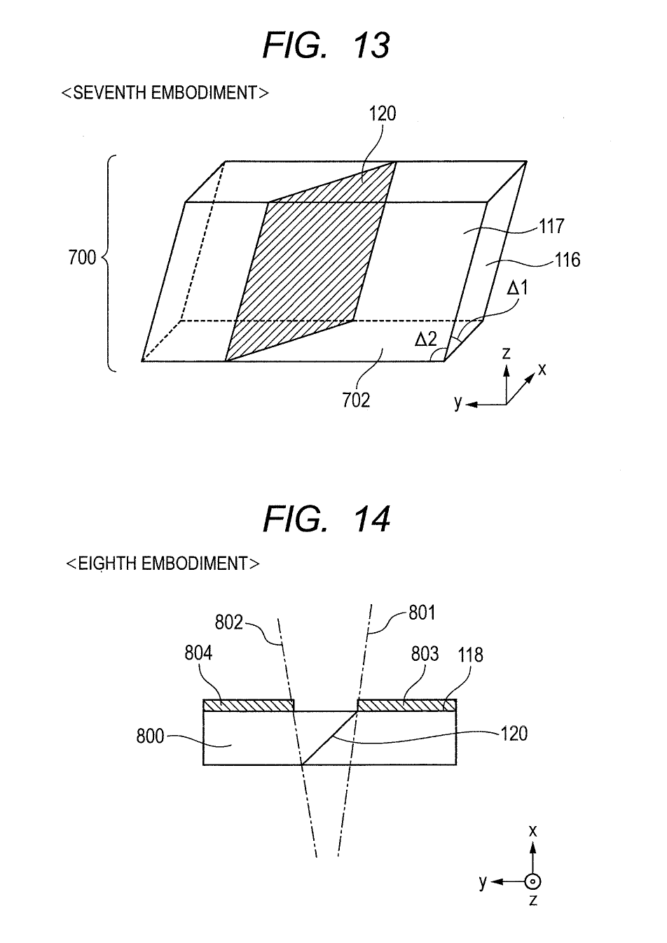

FIG. 13 is a perspective view showing a seventh embodiment of a beam splitter. Although the beam splitter 109 has been set as the rectangular parallelepiped and taken as such a configuration that the light beam whose deflection angle is zero is vertically launched into the first through third side planes 116, 117 and 118, the present invention is not limited to it. There is no problem even if as in the beam splitter 700 shown in FIG. 13, for example, light beams may obliquely be incident on respective planes or surfaces. That is, an angle Δ1 formed between a second side plane 117 and a lower plane 702, or an angle Δ2 formed between a first side plane 116 and the lower plane 702 may not be 90°. A ¼ wave plate 110 may rotatably be attached with a z direction in the drawing or a y direction in the drawing being taken as an axis. This can bring about the following advantageous effects.

An optical part normally generates small stray light beams reflected at its incident plane or transmission plane. For example, a stray light beam reflected without penetrating through the second side plane 117 after being reflected by the polarization selective reflection film 120, and a stray light beam reflected by the ¼ wave plate 110 without penetrating therethrough proceeds straight toward the projected plane. Even in such a case, when the tilt angle corresponding to the angle Δ1 or Δ2 of the beam splitter 109 is provided such that the angle to the optical axis of each stray light beam reaches greater than or equal to the maximum scan angle ±2·θmax or ±2·θmax of the image-projecting light beam, or the ¼ wave plate is installed at a tilt, each stray light can be prevented from entering into a projected image. Further, it is also easy to add optical parts for blocking only the stray light beams without affecting the image-projecting light beams. It is thus possible to prevent degradation in image due to the stray light beams.

### Eighth Embodiment

FIG. 14 is a plan view showing an eighth embodiment of a beam splitter. Of the light beams which are reflected by the deflection scanning element 111 and pass through the beam splitter 109, the light beam passing through the polarization selective reflection film 120 causes a small energy loss with respect to each light beam that passes through regions lying thereoutside. Therefore, as in the beam splitter 800 shown in FIG. 14, films 803 and 804 having transmittance approximately equal to that of the polarization selective reflection film 120 are deposited in predetermined locations where light beams are incident, the light beams being larger in deflection angle than light beams 801 and 802 that pass through the ends of the polarization selective reflection film 120 at a third side plane 118. As a result, the intensity of each light beam emitted from the third side plane 118 of the beam splitter 800 can be held constant at the entire deflection angle. It is thus possible to prevent a partial region of a projected image, which is formed by each light beam passing through the polarization selective reflection film 120 from turning dark and to prevent image degradation.

As described above, the scan-type projection devices 100 according to the fifth through eighth embodiments are capable of projecting a large image in a simple configuration only using the beam splitters 109, 600, 700 and 800 small in size and realizing their miniaturization and reductions in their costs.

### Ninth Embodiment

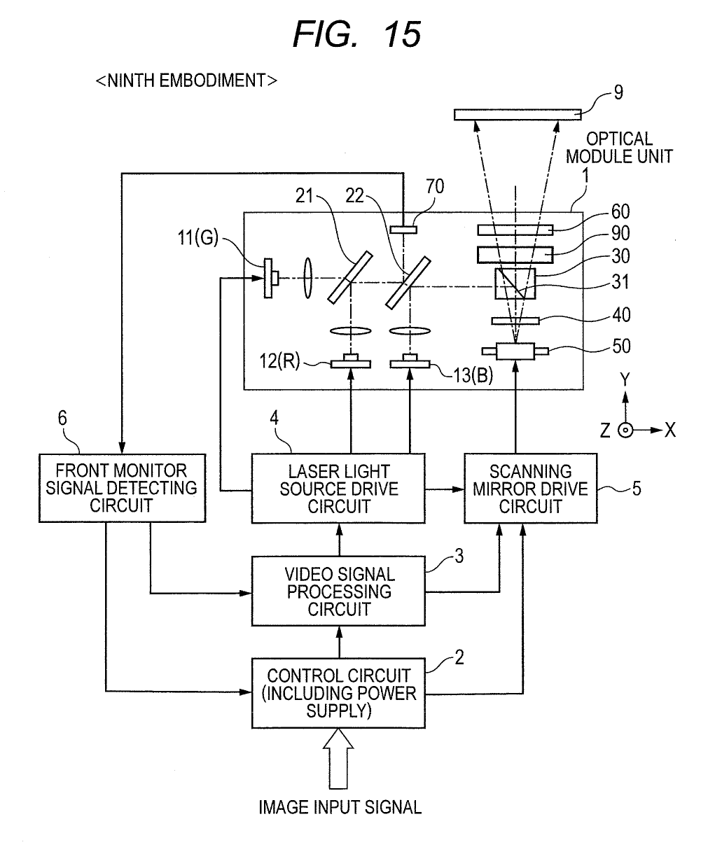

FIG. 15 is an overall configuration diagram showing a ninth embodiment of a scan-type image display device according to the present invention. The ninth embodiment has a configuration in which in the optical module unit 1 of the first embodiment (FIG. 1), a transmission polarization selective element 90 is arranged on the outgoing side of each light beam from the polarizing prism (polarizing beam splitter: PBS) 30 to the screen 9. Providing the polarization selective element 90 makes it possible to prevent a bright spot from occurring approximately in the central part of a projected image on the screen 9 due to the internal reflection of the PBS 30. Incidentally, likewise even in the fifth embodiment (FIG. 7), the transmission polarization selective element 90 may be disposed on the outgoing side of the light beam from the beam splitter 109 to the projected plane.

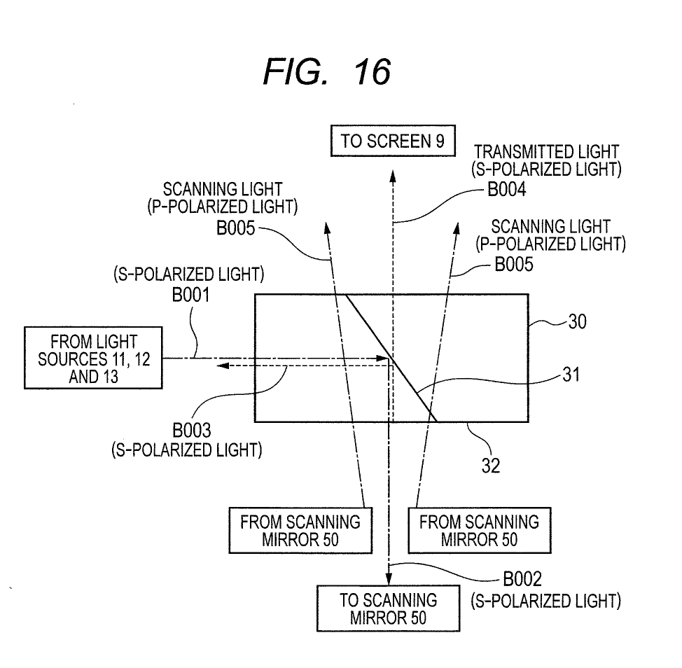

The principle of generation of unnecessary stray light on the scanning screen where the PBS 30 is used, will first be explained with reference to FIG. 16.

The light beams emitted from the light sources 11, 12 and 13 are launched into the PBS 30 as incident light B001. The incident light is set to be S-polarized light with respect to the reflective surface (PBS film) 31 of the PBS 30 and is reflected by the reflective surface or plane 31. While most of the reflected light B002 pass through a side plane 32 of the PBS 30 and proceed to the scanning mirror 50, a light beam of about 0.1% or so is internally reflected by the side plane 32 of the PBS 30. Since the polarization state of the light beam internally reflected by the side plane 32 of the PBS 30 remains unchanged, most of the light beam is reflected by the reflection surface 31 of the PBS 30 and proceeds to the direction of each light source as the reflected light B003, but a light beam from about 0.1% to about 1% proceeds in the direction of the screen 9 as transmitted light B004. The amount of the transmitted light B004 is extremely small with respect to scanning light B005 (P-polarized light) for forming an image. Since, however, the position thereof is fixed approximately to the center of the screen, a problem arises in that the transmitted light is recognized as a bright spot caused by unnecessary stray light.

Thus, in the present embodiment, the transmission polarization selective element 90 is disposed to remove the bright spot and thereby improve image quality. The transmission polarization selective element 90 may be one which causes only a light beam in a specific polarization direction to proceed straight and penetrate therethrough. A so-called polarizing filter can be used. Since the polarization direction of the scanning light B005 which forms the image and that of the transmitted light B004 which forms the bright spot, are orthogonal to each other, the transmitted light B004 which forms the bright spot by the unnecessary stray light can be blocked if the optical axis of the polarization selective element 90 is set in such a manner that only the polarized light corresponding to the scanning light B005 is transmitted therethrough.

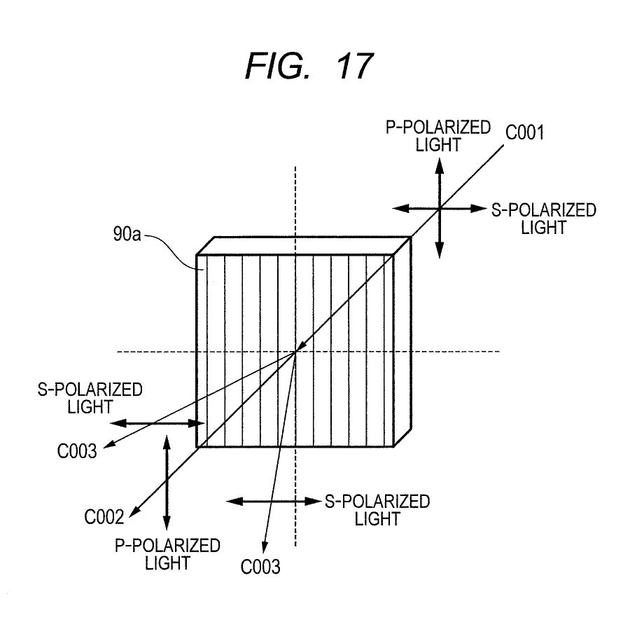

FIG. 17 is a diagram showing another configuration example of the transmission polarization selective element 90.

A periodic structure that changes in refractive index or optical phase is formed on a transmission polarization selective element 90a. A light beam in a specific polarization direction (P-polarization component herein) proceeds straight with respect to incident light C001 to assume output light C002. However, a light beam in a specific polarization direction (each S-polarization component herein) is diffracted so that its traveling direction is changed, thus resulting in each output light C003. By virtue of the transmission polarization selective element 90a, each light beam in the polarization direction (S-polarized light) at which each bright spot occurs due to unnecessary stray light, is deflected, thereby making it possible to prevent the occurrence of the bright spot. Although a so-called diffraction grating in one direction is illustrated in the same drawing, diffraction gratings are combined in a two-dimensional direction to diffract the light beam.

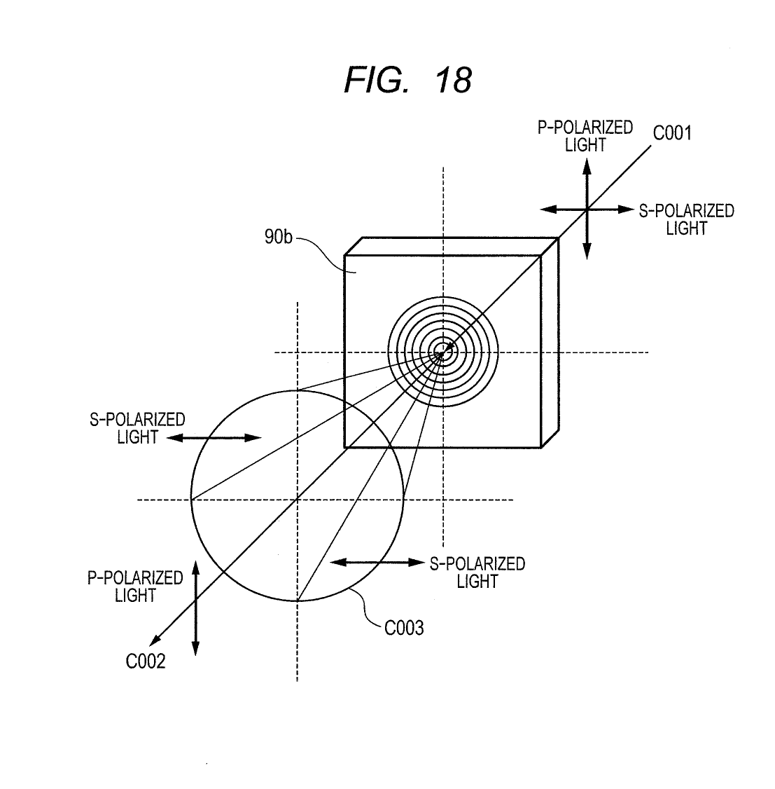

FIG. 18 is a diagram showing a further configuration example of the transmission polarization selective element 90.

An approximately concentric periodic structure that changes in refractive index or optical phase is formed on a transmission polarization selective element 90b. Light beams in a specific polarization direction (S-polarization components herein) are diffracted with respect to incident light C001 to assume output light C003, followed by being diffused radially. The light beams in the polarization direction, which generate bright spots by unnecessary stray light can be diffused by the same transmission polarization selective element.

Thus, according to the ninth embodiment, it is possible to eliminate a bright spot produced approximately in the central part of a projected image by using a polarizing beam splitter (PBS) and prevent degradation in image quality. Incidentally, the transmission polarization selective element 90 can also be formed with a periodic structure in which FIGS. 17 and 18 are combined together. Although the region in which the periodic structure is formed is limited to the element's central part in FIG. 18, the region for the formation of the periodic structure may be either provided over the entire element or limited only to a region equivalent to the diameter of an incident light beam.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A scan-type image display device which scans each light beam and displays an image on a screen, comprising:
at least one light source which emits the light beam;
a light source drive circuit which controls the intensity of the light beam emitted from the light source according to an image signal;
a scanning mirror which causes the light beam to be incident on a mirror plane of the scanning mirror approximately vertically in such a manner that the light beam is approximately vertically reflected;
a scanning mirror drive circuit which drives the scanning mirror such that its mirror plane two-dimensionally turns in a repetitive manner by a predetermined scan angle; and
a polarizing prism which reflects the light beam incident from the light source in such a manner that the light beam is launched into the scanning mirror through a ¼ wave plate, the polarizing prism causing the light beam reflected by the scanning mirror and having passed through the ¼ wave plate to penetrate therethrough in such a manner that the light beam is projected on the screen,
wherein the polarizing prism is shaped in the form of a hexahedron and assumes a configuration in which a polarizing beam splitter film (PBS film) is disposed approximately in a diagonal direction of the hexahedron, the polarizing beam splitter film (PBS film) reflecting the light beam or allowing the light beam to penetrate therethrough, and
wherein when a dimension of the polarizing prism in an outgoing direction (taken as a Y direction below) of the light beam to the screen is A and a dimension thereof in a direction (taken as an X direction below) of incidence of the light beam from the light source is B, the polarizing prism holds a relationship of A<B.

2. The scan-type image display device according to claim 1, wherein the polarizing prism is shaped in the form of a rectangular parallelepiped, and
wherein at a plane of incidence of the light beam from the scanning mirror, one end of the PBS film is laid out at a position deviated inside by a difference (A−B) between the dimensions A and B from an end of the incident plane so as to intersect with the incident plane at an angle of approximately 45°.

3. The scan-type image display device according to claim 1, wherein the polarizing prism has outer portions in a X-direction region through which the light beam passes by performing repetitive rotational drive of the scanning mirror by a predetermined scan angle in the X direction, the outer portions being obliquely cut in a traveling direction of the light beam at at least one of two planes opposite in the X direction.

4. The scan-type image display device according to claim 1, wherein the polarizing prism has outer portions in a Z-direction region through which the light beam passes by performing repetitive rotational drive of the scanning mirror by a predetermined scan angle in the Z direction, the outer portions being obliquely cut in a traveling direction of the light beam at at least one of two planes opposite in a direction (taken as a Z direction below) orthogonal to the X and Y directions.

5. A polarizing prism comprising:
a form of hexahedron; and
a polarizing beam splitter film (PBS film) which reflects each light beam or allows the same to penetrate therethrough, the polarizing beam splitter film being disposed approximately in a diagonal direction of the hexahedron,
wherein the hexahedral form is rectangular in terms of sectional shapes of planes including reflecting and penetrating optical axes of the light beam, and
wherein the PBS film is configured so as to intersect with a long side of the rectangle at an angle of approximately 45° assuming that a vertex position of the rectangle is a starting point at one end thereof and a position deviated inside from the vertex of the rectangle as viewed on the long side is an end point at the other end thereof.

6. A polarizing prism comprising:
a form of hexahedron; and
a polarizing beam splitter film (PBS film) which reflects each light beam or causes the same to penetrate therethrough, the polarizing beam splitter film being disposed approximately in a diagonal direction of the hexahedron,
wherein the hexahedral form is trapezoidal in terms of sectional shapes of planes including reflecting and penetrating optical axes of the light beam, and
wherein the PBS film is configured so as to intersect with a short side of the trapezoid and a long side thereof at an angle of approximately 45° assuming that a vertex position of the trapezoid on the short side is a starting point at one end thereof and a vertex position thereof on the long side is an end point at the other end thereof.

7. A scan-type projection device which scans a light beam on a projected plane and projects a two-dimensional image thereon, comprising:
at least one laser light source which emits the light beam as divergent light;
a collimator lens which changes the light beam to approximately parallel light or weak convergent light;
a deflection scanning element which scans the light beam on the projected plane; and
a beam splitter which is disposed between the collimator lens and the deflection scanning element, the beam splitter causing the light beam after having passed through the collimator lens to reflect in a direction of the deflection scanning element, the beam splitter causing the light beam reflected by the deflection scanning element to penetrate in a direction of the projected plane,
wherein the beam splitter has a first plane on which the light beam after having passed through the collimator lens is incident, the first plane being smaller in area than a second plane on which the light beam reflected from the deflection scanning element is incident.

8. A scan-type projection device which scans each light beam on a projected plane and projects a two-dimensional image thereon, comprising:
at least one laser light source which emits the light beam as divergent light;
a collimator lens which changes the light beam to approximately parallel light or weak convergent light;
a deflection scanning element which scans the light beam on the projected plane; and
a beam splitter which is disposed between the collimator lens and the deflection scanning element, the beam splitter causing the light beam after having passed through the collimator lens to reflect in a direction of the deflection scanning element, the beam splitter causing the light beam reflected by the deflection scanning element to penetrate in a direction of the projected plane,
wherein the beam splitter has a shape of an approximately rectangular parallelepiped and is so configured that the respective areas of two planes opposite to the deflection scanning element, of six planes forming the approximately rectangular parallelepiped are larger than the respective areas of other four planes.

9. The scan-type projection device according to claim 7, comprising a ¼ wave plate provided between the beam splitter and the deflection scanning element,
wherein the ¼ wave plate has the function of rotating a polarization direction of a light beam that passes in such a manner that a polarization direction of a second light beam reflected by the deflection scanning element and incident onto the beam splitter is approximately orthogonal to a polarization direction of a first light beam emitted from the laser light source and incident onto the beam splitter, and
wherein the beam splitter has the function of reflecting a light beam emitted from the laser light source and incident on the beam splitter in a first polarization direction of the light beam and allowing the light beam to penetrate in a second polarization direction orthogonal to the first polarization direction.

10. The scan-type projection device according to claim 7, wherein the beam splitter comprises at least two transparent plates bonded at a predetermined mating surface, and
wherein a polarization selective reflection film is formed at all or part of the predetermined mating surface.

11. The scan-type image display device according to claim 1, wherein a polarization selective element causes only a light beam in a specific polarization direction to proceed straight and penetrate therethrough, the polarization selective element being disposed on the outgoing side of the light beam from the polarizing prism to the screen.

12. The scan-type projection device according to claim 7, wherein a polarization selective element causes only a light beam in a specific polarization direction to proceed straight and penetrate therethrough, the polarization selective element being disposed on the outgoing side of the light beam from the beam splitter to the projected plane.
